(19) United States
(12) Patent Application Publication
(10) Pub. No.: US 2004/0015881 A1
(43) Pub. Date: Jan. 22, 2004

(54) Information processing device, system and method for generating trace information of the information processing device

(75) Inventor: Kiichiro Iga, Kasugai (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: FUJITSU LIMITED

(21) Appl. No.: 09/964,369

(22) Filed: Sep. 28, 2001

(30) Foreign Application Priority Data
May 11, 2001 (JP) 2001-141566

(51) Int. Cl. G06F 9/44

(52) U.S. Cl. 717/128; 717/155

(57) ABSTRACT

A method for generating trace information of an information processing device that monitors operation of a processing unit without depending on the operating frequency of the processing unit. The device includes a processing unit and an interface device. The processing unit generates operational information when branching occurs, and the interface device has a buffer circuit for receiving the operational information from the processing unit. The method includes generating an absolute branching destination address each time a branching occurs, storing the generated absolute branching destination address in the buffer circuit, generating a flag based on the absolute branching destination address, storing the flag in the buffer circuit in association with the absolute branching destination address, generating a relative branching destination address based on the stored absolute branching destination address, and outputting the absolute branching destination address or the relative branching destination address based on the flag.

### BACKGROUND OF THE INVENTION

The present invention relates to an information processing device, an information processing system, and a method for generating trace information of the information processing device. More particularly, the present invention relates to a method for generating trace information of an information processing device incorporating an interface device to provide operational information of a processing unit to an external device, to an information processing device, and to an information processing system.

An information processing device, such as a microcomputer, incorporates an interface device to output operational information of a central processing unit (CPU) to an external monitoring device, such as an emulator and check the operation of the device or debug a program of the device.

As is well known in the art, the operating speeds of microcomputers have been increasing. Thus, operation monitoring (program trace) must be performed for CPUs that operate at high speeds.

FIG. 1 is a schematic block diagram illustrating a first example of a prior art microcomputer 51. The microcomputer 51 includes a CPU 52 and an emulator interface device 53. The emulator interface device 53 provides operational information of the CPU 52 to an externally connected emulator device (not shown).

When branching occurs during execution of a program, the CPU 52 provides the interface device 53 with a branching occurrence signal BEN and a branching designation address BADR, both of which represent the operational information of the CPU 52.

The interface device 53 includes a control circuit 54, a branching designation address storage buffer circuit 55 and an output circuit 56.

The control circuit 54 receives a branching occurrence signal BEN from the CPU 52 and generates a status output signal that includes branching state information. The branching state information provides indication that branching has occurred in the program, based on the branching occurrence signal BEN. The status output signal is provided to the emulator device (not shown).

The buffer circuit 55 receives and stores the branch designation address BADR from the CPU 52. The stored branching designation address BADR is provided to the output circuit 56 in accordance with an order to which the address BADR was stored.

The output circuit 56 receives the branching designation address BADR and generates a branching designation address output based on the branching designation address BADR. The branching designation address output is provided to the emulator device within a number of cycles.

In addition to the branch designation address BADR, the buffer circuit 55 receives and stores a command fetch number (not shown) for the branching period. The stored fetch number is provided to the emulator device together with the designation address BADR.

Based on the branching state information, the branching designation address BADR, and the command fetch number, the emulator device recognizes the command at which the branching occurred. The emulator device then traces the operation of the CPU 52.

To transmit information indicative of the operating state of the microcomputer, which operates in real time and at a high speed, a cable that enables data transmission in compliance with the operating frequency of the microcomputer is used. However, such cable, that is applicable to the operating frequency of the microcomputer, is expensive.

Inexpensive cables, each of which may not be applicable to the operating frequency of the microcomputer when used alone, may be used. In such case, the cables are utilized in a time-sharing manner. In other words, information indicative of the operating state of the microcomputer is provided to the emulator device in parallel. Such as, the interface frequency may be decreased to be lower than the operating frequency of the microcomputer.

However, both the usage of an expensive cable and the usage of inexpensive cables increase the number of interface terminals, which, in turn, increases costs.

FIG. 2 is a schematic block diagram illustrating a second example of a prior art microcomputer 61. The microcomputer 61 includes a CPU 62 and an interface device 63.

When a branching occurs during the execution of a program, the CPU 62 generates an absolute branching occurrence signal ABEN or a relative branching occurrence signal RBEN. Further, the CPU 62 generates an absolute branching designation address ABADR in correspondence with the absolute branching occurrence signal ABEN and a relative branching designation address RBADR in correspondence with the relative branching occurrence signal RBEN.

The absolute branching designation address ABADR is allocated in advance to every executed command. The relative branching designation address RBADR indicates the difference between the address of the command where the branching occurred and the address of the command executed next.

The interface device 63 includes a control circuit 64, a buffer circuit 65, and an output circuit 66. The buffer circuit 65 stores the absolute branching designation address ABADR or the relative branching designation address RBADR and provides the output circuit 66 with the addresses ABADR, RBADR in accordance with the order the addresses ABADR, RBADR were stored. The bit number of the relative branching designation address RBADR stored in the buffer circuit 65 is less than that of the absolute branching designation address ABADR.

Accordingly, the number of cycles required to provide the emulator device with the relative branching designation address RBADR is less than that of the first prior art example. Thus, this substantially increases the data transmission speed when providing the emulator device with the operational information of the CPU 62. Accordingly, the interface terminal number does not have to be increased.

However, in the microcomputer 61, when the buffer circuit 65 lacks buffer space, the buffer circuit 65 deletes the branching designation address that was received earliest. Thus, when the buffer circuit 65 receives a new branching designation address from the CPU 62 in a state in which there in not enough buffer space, the buffer circuit 65 deletes the earliest branching designation address to store the new branching designation address.

Therefore, command tracing is not performed when an address is deleted and the next branching designation address output from the buffer circuit 65 is a relative branching designation address.

Further, if all of the branching designation addresses stored in the buffer circuit 65 are relative branching designation addresses when an address is deleted, subsequent command tracing becomes impossible. In addition, the deletion of addresses frequently occurs when branching frequently occurs in a program. When address deletion occurs frequently, command tracing is not performed at many branchings.

### SUMMARY OF THE INVENTION

It is an object of the present invention to provide an information processing device having a CPU operatively coupled thereof, a method for generating trace information of the information processing device, and an information processing system that monitor the operation of the CPU regardless of operating frequency of the CPU.

To achieve the above object, the present invention provides a method for generating trace information of an information processing device, the information processing including a processing unit and an interface device. The processing unit generates operational information when branching occurs during processing, and the interface device has a buffer circuit for receiving the operational information of the branching from the processing unit. The method includes generating an absolute branching destination address each time a branching occurs when the processing unit performs processing, storing the generated absolute branching destination address in the buffer circuit, generating a flag based on the absolute branching destination address, storing the flag in the buffer circuit in association with the absolute branching destination address, generating a relative branching destination address based on the stored absolute branching destination address, and outputting, based on the flag, either one of the absolute branching destination address and the relative branching destination address.

A further perspective of the present invention is an information processing device, wherein the information processing device includes a processing unit for generating a branching occurrence signal and an absolute branching destination address each time a branching occurs during processing. A determination circuit is connected to the processing unit to compare a formerly generated absolute branching destination address and a subsequently generated absolute branching destination address and generate a flag in accordance with the comparison result. A buffer circuit is connected to the processing unit and the determination circuit to associate the absolute branching destination address with the flag, sequentially store the associated absolute branching destination address and flag, and output the absolute branching destination address and the flag in the stored order. An output circuit is connected to the buffer circuit to generate a relative branching destination address based on the stored absolute branching destination address. The output circuit outputs, based on the flag, either one of the absolute branching destination address and the relative branching destination address.

A further aspect of the present invention is an information processing device, wherein the information processing device includes a processing unit for generating a branching occurrence signal, an absolute branching destination address, and a command fetch number each time a branching occurs during processing. A determination circuit is connected to the processing unit to compare a formerly generated absolute branching destination address and a subsequently generated absolute branching destination address and generate a flag that is in accordance with the comparison result. A buffer circuit is connected to the processing unit and the determination circuit to associate the absolute branching destination address with the flag and the command fetch number, sequentially store the associated absolute branching destination address, flag, and fetch number, and output the absolute branching destination address, the flag, and the command fetch number in the stored order. An output circuit is connected to the buffer circuit to generate a relative branching destination address based on the stored absolute branching destination address. The output circuit outputs the command fetch number and, based on the flag, either one of the absolute branching destination address and the relative branching destination address.

A further perspective of the present invention is an information processing system, wherein the information processing system includes a processing unit for generating a branching occurrence signal and an absolute branching destination address each time a branching occurs during processing. A determination unit is connected to the processing unit to compare a formerly generated absolute branching destination address and a subsequently generated absolute branching destination address and generate a flag in accordance with the comparison result. A buffer unit is connected to the processing unit and the determination unit to associate the absolute branching destination address with the flag, sequentially store the associated absolute branching destination address and flag, and output the absolute branching destination address and the flag in the stored order. An output unit is connected to the buffer circuit to generate a relative branching destination address based on the stored absolute branching destination address. Based on the flag, the output unit outputs either one of the absolute branching destination address and the relative branching destination address.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood with reference to the following description of the presently preferred embodiments together with the accompanying drawings in which:

FIG. 1 is a schematic block diagram illustrating a first example of a prior art microcomputer;

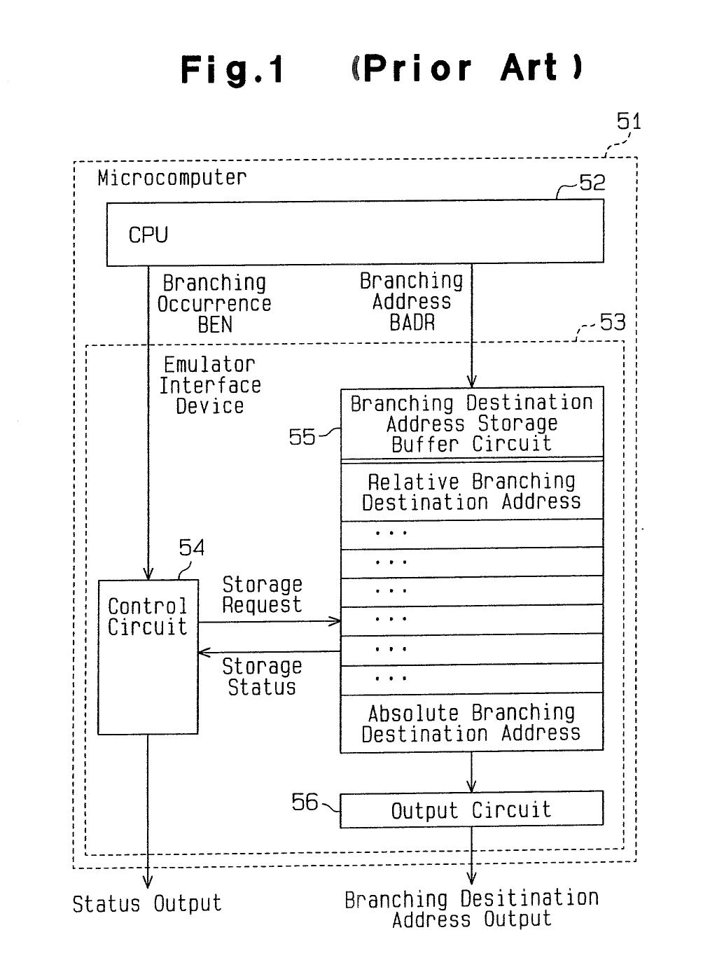

FIG. 2 is a schematic block diagram illustrating a second example of a prior art microcomputer;

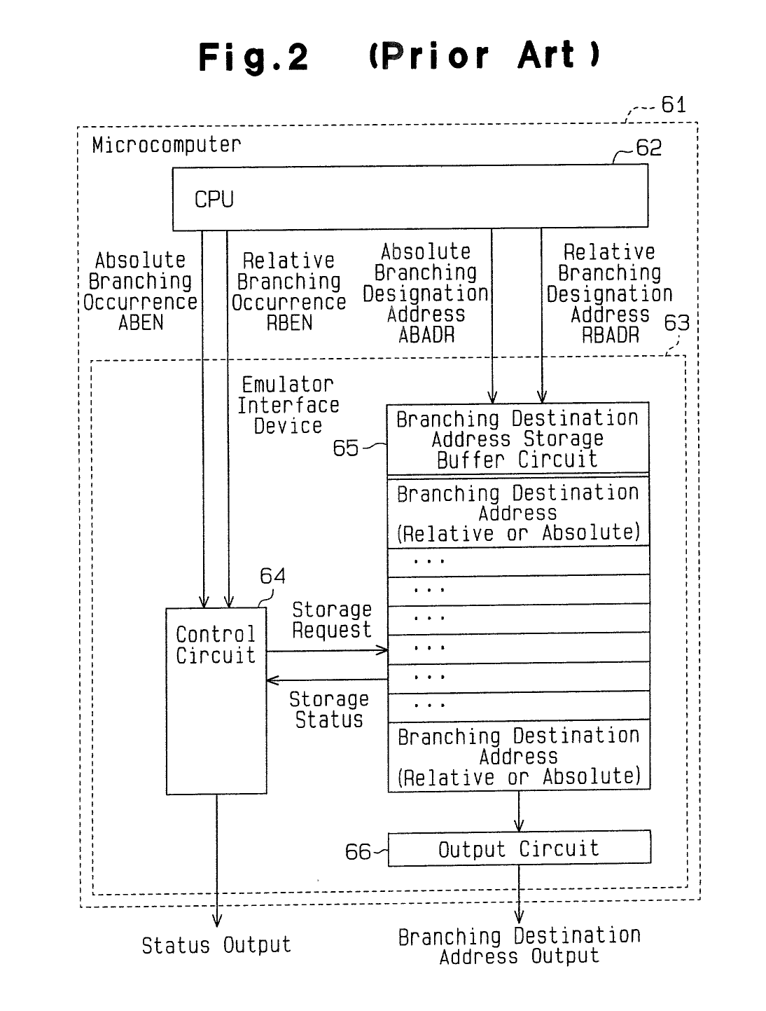

FIG. 3 is a schematic block diagram of a microcomputer according to the present invention;

FIG. 4 is a waveform chart illustrating the operation of the microcomputer of FIG. 3; and

FIG. 5 is a waveform chart illustrating the operation of the microcomputer of FIG. 3.

### DETAILED DESCRIPTION OF THE PREFERRED EMBODIMENTS

In the drawings, like numerals are used for like elements throughout.

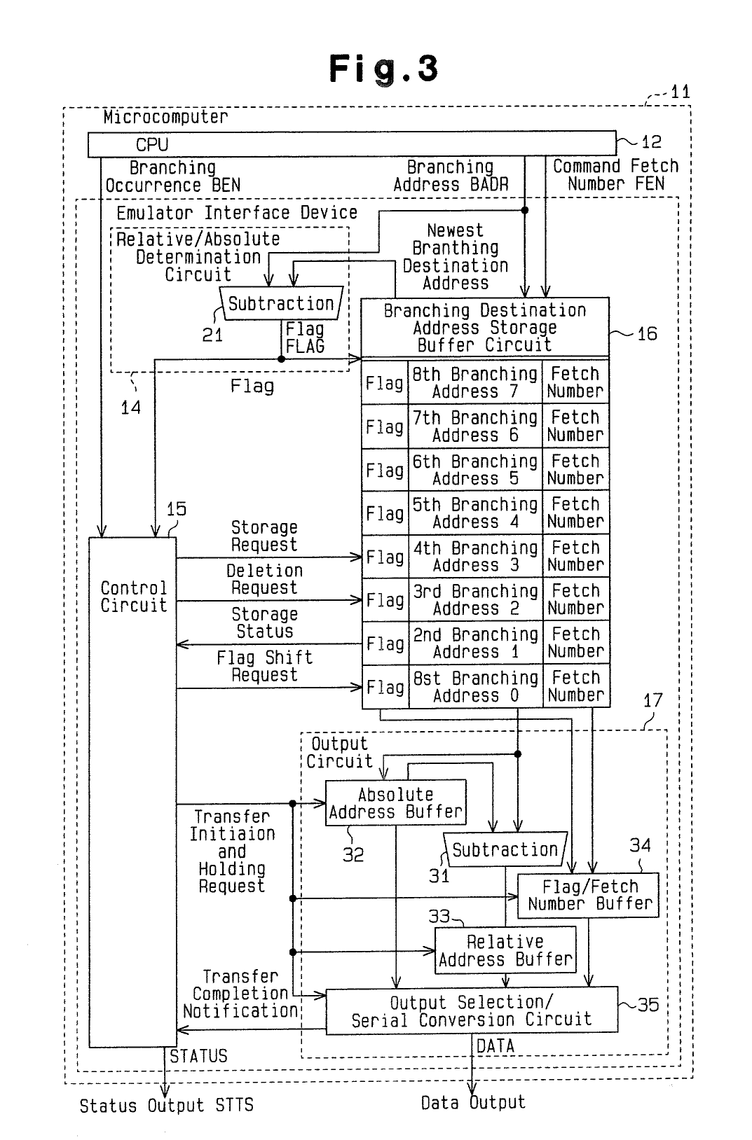

FIG. 3 is a schematic block diagram of a microcomputer 11 according to a preferred embodiment of the present invention. The microcomputer 11 includes a CPU 12 and an emulator interface device 13, which provides the operational information of the CPU 12 to an externally connected emulator device (not shown).

When a branching occurs during execution of a program in response to a branching command, the CPU 12 generates a branching occurrence signal BEN and a branching designation address BADR, which is allocated to the branching command. The CPU 12 provides the branching occurrence signal BEN and the branching designation address BADR to the interface device 13. Further, the CPU 12 provides the interface 13 with a command fetch number FEN, which is based on the previous branching command. The branching designation address BADR is an absolute address.

The interface device 13 includes a relative/absolute determination circuit 14, a control circuit 15, a branching designation address storage buffer circuit 16, and an output circuit 17.

The buffer circuit 16 provides the branching designation address BADR and the command fetch number FEN, which are received from the CPU 12, to the output circuit 17 in an order to which the address BADR and the fetch number FEN are stored in the buffer circuit 16. In other words, the buffer circuit 16 outputs information in compliance with the first in, first out (FIFO) technique.

In the preferred embodiment, the buffer circuit 16 stores eight addresses, for example, first to eighth branching designation addresses BADR0 to BADR7 (indicated in the drawings as first to eighth branching designation addresses 0 to 7). The first branching designation address BADR0 represents the earliest data stored in the buffer circuit 16. The eighth branching designation address BADR7 represents the newest address stored in the buffer circuit.

The determination circuit 14 includes a subtraction circuit 21 and receives the branching designation address BADR from the CPU 12 and the eighth branching destination address BADR7 from the buffer circuit 16.

The subtraction circuit 21 computes an address difference (relative value) between the branching designation address BADR and the eighth designation address BADR7. The subtraction circuit 21 generates a flag at a high level when the computed relative value is in a predetermined range, which is stored in the subtraction circuit 21. The output circuit 17 outputs a relative branching designation address (hereinafter referred to as relative address) based on the high flag FLG.

When the computed relative value is outside the predetermined range, the subtraction circuit 21 generates a flag FLG at a low level. The output circuit 17 outputs an absolute branching designation address (hereinafter referred to as absolute address) based on the low flag FLG. The subtraction circuit 21 provides the flag FLG to the control circuit 15 and the buffer circuit 16.

The control circuit 15 receives the branching occurrence signal BEN from the CPU 12 and receives the flag FLG from the determination circuit 14. Based on the branching occurrence signal BEN and the flag FLG, the control circuit 15 generates a status output signal STTS, which includes either relative branching occurrence state information or absolute branching occurrence state information. Then, the control circuit 15 provides the status output signal STTS to the emulator device.

The control circuit 15 generates a storage request signal based on the branching occurrence signal BEN and provides the storage request signal to the buffer circuit 16. In response to the storage request signal, the buffer circuit 16 stores the flag FLG, which is received from the determination circuit 14, and the branching designation address BADR and the command fetch number FEN, which are received from the CPU 12.

When there is not enough space for storing the branching designation address BADR, that is, when the buffer circuit 16 is full, the buffer circuit 16 provides the control circuit 15 with storage status information indicating that the buffer section of the buffer circuit 16 is full.

In response, the control circuit 15 generates and provides the buffer circuit 16 with a deletion request signal and a flag shift request signal.

In response to the deletion request signal, the buffer circuit 16 deletes the first branching designation address BADR0 (earliest address) and the corresponding command fetch number FEN, which are stored in the buffer circuit 16. Then, the buffer circuit 16 receives a new branching designation address BADR and a command fetch number FEN from the CPU 12.

In response to the flag shift request signal, the buffer circuit 16 forcibly shifts the flag FLG of the second branching designation address BADR1 (the address that becomes earliest subsequent to the address deletion) to a low level. In other words, when the buffer circuit 16 becomes full, subsequently the output flag FLG goes low to output an absolute address from the buffer circuit 16. In this state, the control circuit 15 generates and provides the emulator device with a status output signal STTS, which includes address deletion state information.

In this manner, the buffer circuit 16 stores the flag FLG and the command fetch FEN together with the branching designation address BADR. The buffer circuit 16 then provides the branching designation address BADR, the flag FLG, and the command fetch number FEN to the output circuit 17.

The output circuit 17 includes a subtraction circuit 31, an absolute address buffer 32, a relative address buffer 33, a flag/fetch number buffer 34, and an output selection/ serial conversion circuit 35.

The subtraction circuit 31 and the absolute address buffer 32 receives the first to eighth branching designation addresses BADR0-BADR7 from the buffer circuit 16. The flag/fetch number buffer 34 receives the flag FLG and the command fetch number FEN from the buffer circuit 16.

When the absolute address buffer 32 receives a transfer initiation request from the control circuit 15, the absolute address buffer 32 provides the branching designation address BADR (absolute address), received from the buffer circuit 16, to the subtraction circuit 31 and the output selection/serial conversion circuit 35.

The subtraction circuit 31 computes a relative value (relative address) from the absolute address, received from the absolute address buffer 32, and the branching designation address BADR, received from the buffer circuit 16. The relative address is provided to the relative address buffer 33.

When the relative address buffer 33 receives a transfer request initiation signal from the control circuit 15, the relative address buffer 33 provides the relative address to the output selection/serial conversion circuit 35.

When the flag/fetch number buffer 34 receives a transfer initiation request signal from the control circuit 15, the flag/fetch number buffer 34 provides the flag FLG and the command fetch number FEN to the output selection/serial conversion circuit 35.

When the output selection/serial conversion circuit 35 receives a transfer request initiation signal from the control circuit 15, the output selection/serial conversion circuit 35 serial-converts the command fetch number FEN. The serial-converted command fetch number (data output DATA) is provided to the emulator device. Then, the output selection/serial conversion circuit 35 serial-converts either the absolute address or the relative address based on the flag FLG received from the flag/fetch number buffer 34. The serial-converted absolute address or relative address (data output DATA) is provided to the emulator device. Then, the output selection/serial conversion circuit 35 provides the control circuit 15 with a transfer completion notification signal.

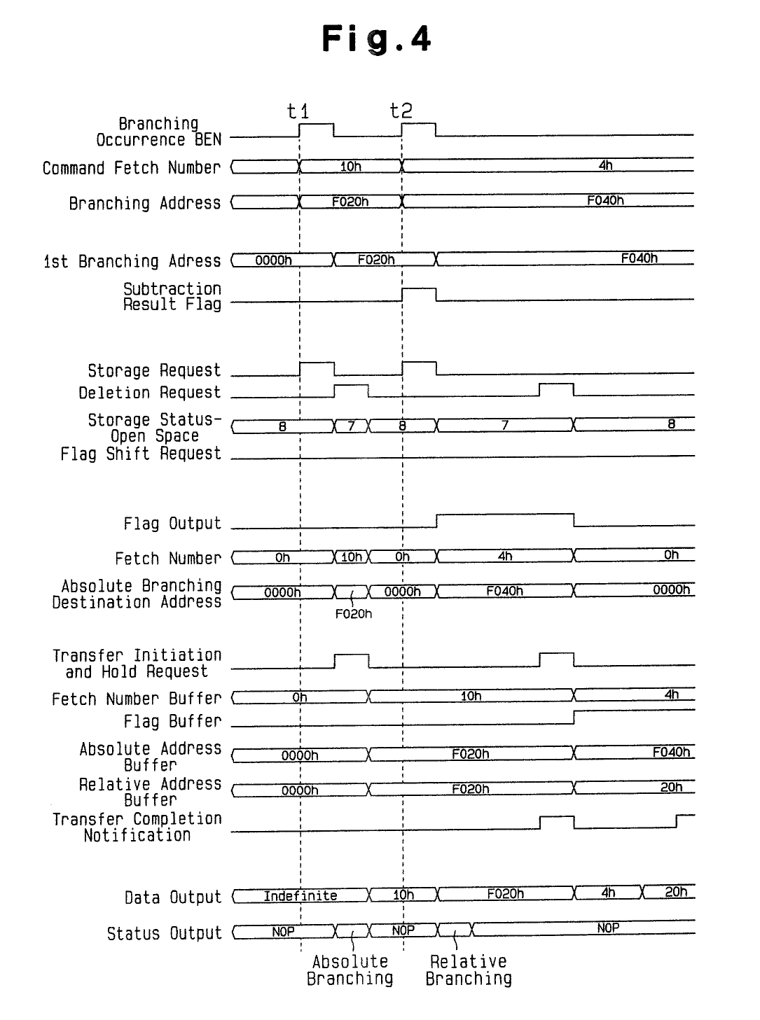

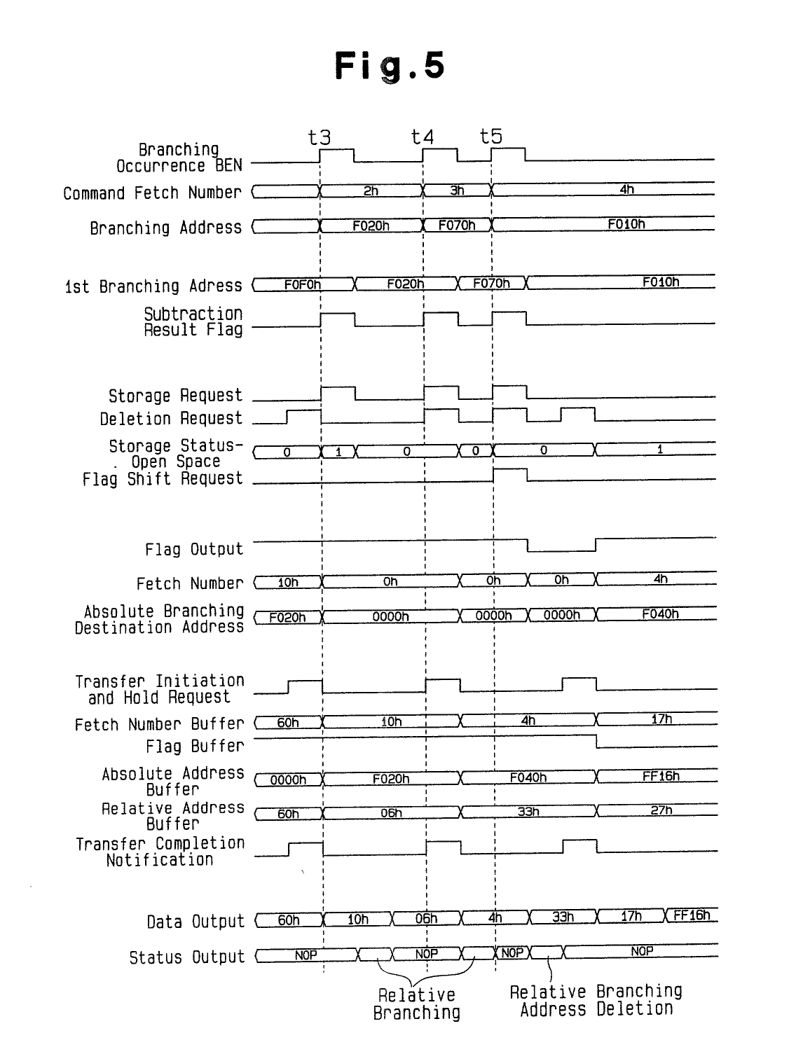

Operations of the microcomputer 11 will now be discussed with reference to FIGS. 4 and 5.

FIG. 4 is a timing chart taken when address deletion does not occur in the buffer circuit 16. FIG. 5 is a timing chart taken when address deletion occurs in the buffer circuit 16.

Referring to FIG. 4, when a branching occurs at time t1, the CPU 12 generates the branching occurrence signal BEN at a high level, and outputs the branching occurrence signal BEN, a commend fetch number “10h”, and a branching designation address “F020h”. If the address relative value computed by the subtraction circuit 21 is not included in the predetermined range, the determination circuit generates the flag FLG at a low level to output the absolute address.

The control circuit 15 generates the storage request signal at a high level and provides the high storage request signal to the buffer circuit 16. In response to the high storage request signal, the buffer circuit 16 stores the command fetch number “10h”, the flag FLG, and the branching designation address “F020h”.

Then, the control circuit 15 generates the status output signal STTS, which includes the absolute branching occurrence state information, in accordance with the low flag FLG. Subsequently, the output circuit 17 sequentially outputs data outputs DATA, which includes the command fetch number “10h” and the absolute address “F020h” in response to the transfer initiation request signal.

Then, when a branching occurs at time t2, the CPU 12 generates a branching occurrence signal at a high level and outputs the branching occurrence signal, a command fetch number “4h”, and a branching designation address “F040h”.

The subtraction circuit 21 of the determination circuit 14 computes a relative value “20h” between the newest branching designation address “F020h” and the branching designation address “F040h”. In this case, when the subtraction circuit 21 determines that the relative value “20h” is included in the predetermined range, the subtraction circuit 21 generates the flag FLG at a high level to output the relative address.

The control circuit 15 provides the buffer circuit 16 with the storage request signal. The buffer circuit 16 stores the command fetch number “4H“, the flag FLG, and the branching destination address “F040h” in response to the storage request signal.

Then, the control circuit 15 generates the status output signal STTS, which includes relative branching occurrence state information. Afterward, the output circuit 17 sequentially outputs the data output DATA, which includes the command fetch number “4h” and the relative address “20h”.

Referring to FIG. 5, when a branching occurs at time t5 after branchings occur at time t3 and time t4, the CPU 12 generates the branch occurrence signal BEN at a high level and outputs the branching occurrence signal BEN, the command fetch number “4h”, and the branching destination address “F010h”.

The subtraction circuit 21 of the determination circuit 14 computes a relative value between the newest branching destination location “F070h” and the branching destination address “F010h”. When the relative value is included in the predetermined range, the subtraction circuit 21 generates the flag FLG at a high level to output the relative address.

Then, the control circuit 15 provides the storage request signal to the buffer circuit 16. In this state, the buffer circuit 16 dos not have any open space. Thus, the control circuit 15 provides the deletion request signal to the buffer circuit 16.

In response to the deletion request signal, the buffer circuit 16 deletes the earliest address. In this state, the buffer circuit 16 stores the branching destination address “F010h”, the flag FLG, and the command fetch number “4h”.

Further, the control circuit 15 generates the flag shift request signal at a high level and provides the buffer circuit 16 with the high flag shift request signal.

In response to the high flag shift request signal, the buffer circuit 16 shifts the flag FLG, which corresponds to the address that has become the earliest one subsequent to the address deletion, to a low level.

The control circuit 15 generates the status output signal STTS to indicate the occurrence of a relative branching and address deletion. Then, the output circuit 17 sequentially outputs the data output DATA, which includes the command fetch number “17h” and the absolute address “FF16f” corresponding to the flag shift, to the emulator device based on the transfer initiation request signal of the control circuit 15.

The microcomputer (information processing device) 11 of the preferred embodiment has the advantages described below.

(1) The buffer circuit 16 of the interface device 13 provides the control circuit 15 with storage information of the branching destination address. If the buffer circuit 16 does not have enough space, the control circuit 15 provides the buffer circuit 16 with a branching destination address (earliest branching destination address) deletion request and a flag shift request. In response to the deletion request and the flag shift request, the buffer circuit 16 deletes the earliest branching destination address stored in the buffer circuit 16. Further, the buffer circuit 16 shifts the flag of the branching destination address that has become the earliest one subsequent to the address deletion to output an absolute address. Thus, even if the branching destination address stored in the buffer circuit 16 is deleted, subsequent command tracing is enabled.

(2) The subtraction circuit 21 of the determination circuit 14 generates the flag FLG to output the relative address or the absolute address based on the address difference (relative value) between branching destination addresses. Accordingly, the output circuit 17 outputs the absolute address or the relative address based on the flag FLG. In comparison to outputting the absolute address, the number of cycles is decreased when outputting the relative address, thereby substantially increasing the data transmission speed for command tracing. As a result, the number of interface terminals does not have to be increased, effectively eliminating related costs.

It should be apparent to those skilled in the art that the present invention may be embodied in many other specific forms without departing from the spirit or scope of the invention. Particularly, it should be understood that the present invention may be embodied in the following forms.

The control circuit 15 generates the output selection signal based on the flag FLG and provides the output selection signal to the output selection/serial conversion circuit 35 of the output circuit 17.

The output selection/serial conversion circuit 35 may output the relative address or the absolute address based on the output selection signal.

The information processing device of the present invention may be applied to an information processing system that includes a plurality of devices having one or more functions.

The present examples and embodiments are to be considered as illustrative and not restrictive, and the invention is not to be limited to the details given herein, but may be modified within the scope and equivalence of the following claims.

What is claimed is:

1. A method for generating trace information of an information processing device, wherein the information processing device includes a processing unit and an interface device, wherein the processing unit generates operational information when branching occurs during processing, and wherein the interface device has a buffer circuit for receiving the operational information of the branching from the processing unit, the method comprising the steps of:
generating an absolute branching destination address each time a branching occurs when the processing unit performs processing;
storing the absolute branching destination address in the buffer circuit;
generating a flag based on the absolute branching destination address;
storing the flag in the buffer circuit in association with the absolute branching destination address;
generating a relative branching destination address based on the stored absolute branching destination address; and
outputting, based on the flag, either one of the absolute branching destination address and the relative branching destination address.

2. The method according to claim 1, further comprising the steps of:
deleting a predetermined absolute branching destination address stored in the buffer circuit when the absolute branching destination addresses fully occupy the buffer circuit; and
shifting the flag associated with the deleted predetermined absolute branching destination address to output the absolute branching destination address.

3. The method according to claim 2, further comprising the steps of:
based on the flag, serial-converting either one of the absolute branching destination address and the relative branching destination address; and
outputting the serial-converted branching destination address.

4. An information processing device comprising:
a processing unit for generating a branching occurrence signal and an absolute branching destination address each time a branching occurs during processing;
a determination circuit connected to the processing unit for comparing a formerly generated absolute branching destination address and a subsequently generated absolute branching destination address and generating a flag in accordance with comparison result;
a buffer circuit connected to the processing unit and the determination circuit for sequentially associating the absolute branching destination address with the flag, sequentially storing the associated absolute branching destination address and the flag, and outputting the absolute branching destination address and the flag in order stored; and
an output circuit connected to the buffer circuit for generating a relative branching destination address based on the stored absolute branching destination address, wherein the output circuit outputs, based on the flag, either one of the absolute branching destination address and the relative branching destination address.

5. The device according to claim 4, further comprising:
a control circuit connected to the processing unit, the determination circuit, and the buffer circuit for deleting a predetermined absolute branching destination address stored in the buffer circuit when the absolute branching destination addresses fully occupy the buffer circuit and for shifting the flag associated with the deleted predetermined absolute branching destination address to output the absolute branching destination address from the output circuit.

6. The device according to claim 5, wherein the control circuit generates relative branching occurrence state information or absolute branching occurrence state information based on the branching occurrence signal and the flag and generates address deletion state information when an address in the buffer circuit is deleted.

7. The device according to claim 4, wherein the determination circuit computes a relative value between the formerly generated absolute branching destination address which is most recently stored in the buffer circuit and the subsequently generated absolute branching destination address received from the processing unit, and wherein
the determination circuit generates a first flag to output the absolute branching destination address from the output circuit when the relative value is included in a predetermined range, and generates a second flag to output the relative branching destination address from the output circuit when the relative value is not included in the predetermined range.

8. The device according to claim 4, wherein the output circuit includes:
an absolute address buffer connected to the buffer circuit for storing a first absolute branching destination address received from the buffer circuit;
a subtraction circuit connected to the absolute address buffer and the buffer circuit for computing a relative branching destination address using the first absolute branching destination address and a second absolute branching destination address, which is next output from the buffer circuit after the first absolute branching destination address;
a relative address buffer connected to the subtraction circuit for storing the relative branching destination address; and
a serial-conversion circuit connected to the absolute address buffer and the relative address buffer for serial-converting either one of the first absolute branching destination address and the relative branching destination address and for thereafter outputting the serial-converted branching destination address.

9. An information processing device comprising:
a processing unit for generating a branching occurrence signal, an absolute branching destination address, and a command fetch number each time a branching occurs during processing;
a determination circuit connected to the processing unit for comparing a formerly generated absolute branching destination address and a subsequently generated absolute branching destination address and generating a flag in accordance with comparison result;
a buffer circuit connected to the processing unit and the determination circuit for associating the absolute branching destination address with the flag and the command fetch number, sequentially storing the associated absolute branching destination address, the flag, and the command fetch number, and outputting the absolute branching destination address, the flag, and the command fetch number in order stored; and
an output circuit connected to the buffer circuit for generating a relative branching destination address based on the stored absolute branching destination address, wherein the output circuit outputs the command fetch number and, based on the flag, either one of the absolute branching destination address and the relative branching destination address.

10. The device according to claim 9, further comprising:
a control circuit connected to the processing unit, the determination circuit, and the buffer circuit for deleting a predetermined absolute branching destination address stored in the buffer circuit when the absolute branching destination addresses fully occupy the buffer circuit and for shifting the flag associated with the deleted predetermined absolute branching destination address to output the absolute branching destination address from the output circuit.

11. The device according to claim 10, wherein the control circuit generates relative branching occurrence state information or absolute branching occurrence state information based on the branching occurrence signal and the flag and generates address deletion state information when an address in the buffer circuit is deleted.

12. The device according to claim 9, wherein the determination circuit computes a relative value between the formerly generated absolute branching destination address which is most recently stored in the buffer circuit and the subsequently generated absolute branching destination address received from the processing unit, and wherein the determination circuit generates a first flag to output the absolute branching destination address from the output circuit when the relative value is included in a predetermined range, and generates a second flag to output the relative branching destination address from the output circuit when the relative value is not included in the predetermined range.

13. The device according to claim 9, wherein the output circuit includes:
an absolute address buffer connected to the buffer circuit for storing a first absolute branching destination address received from the buffer circuit;
a subtraction circuit connected to the absolute address buffer and the buffer circuit for computing a relative branching destination address using the first absolute branching destination address and a second absolute branching destination address, which is next output from the buffer circuit after the first absolute branching destination address;
a relative address buffer connected to the subtraction circuit for storing the relative branching destination address; and
a serial-conversion circuit connected to the absolute address buffer and the relative address buffer for serial-converting the command fetch number, outputting the serial-converted command fetch number, serial-converting either one of the first absolute branching destination address and the relative branching destination address, and outputting the serial-converted branching destination address.

14. An information processing system comprising:
a processing unit for generating a branching occurrence signal and an absolute branching destination address each time a branching occurs during processing;
a determination unit connected to the processing unit for comparing a formerly generated absolute branching destination address and a subsequently generated absolute branching destination address and generating a flag in accordance with the comparison result;
a buffer unit connected to the processing unit and the determination unit for associating the absolute branching destination address with the flag, sequentially storing the associated absolute branching destination address and flag, and outputting the absolute branching destination address and the flag in order stored; and
an output unit connected to the buffer circuit for generating a relative branching destination address based on the stored absolute branching destination address, wherein the output unit outputs, based on the flag, either one of the absolute branching destination address and the relative branching destination address.
